(19) United States
(12) Patent Application Publication
(10) Pub. No.: US 2006/0288778 A1
(43) Pub. Date: Dec. 28, 2006

(54) Filling level sensor

(76) Inventors: Hans-Guenter Benner, Kriflel (DE); Karl Eck, Frankfurt (DE); Bernd Pauer, Epustein (DE); Zlatko Penzar, Frankfurt (DE); Knut Schroter, Oberursel (DE)

Correspondence Address: Richard A. Speer;MAYER, BROWN, ROWE & MAW LLP, P.O. Box 2828, Chicago, IL, 60690-2828, US

(21) Appl. No.: 11/473,210

(22) Filed: Jun. 21, 2006

(30) Foreign Application Priority Data
Jun. 24, 2005 (DE) 10 2005 029 788.9

(51) Int. Cl. G01F 23/00

(52) U.S. Cl. 73/313

(57) ABSTRACT

The invention relates to a filling level sensor for a fuel tank 2, comprising a ceramic mounting plate 5 with a resistance network 6 arranged thereon and a contact structure 8 for the detection of an electrical filling level signal, and a cover 9 connected to the mounting plate 5, the cover 9 and the mounting plate 5 forming a housing 10. The cover 9 has at least one bead 11.

The subject of the invention is a filling level sensor for a fuel tank, comprising a ceramic mounting plate with a resistance network arranged thereon and a contact structure for the detection of an electrical filling level signal, and a cover connected to the mounting plate, the cover and the mounting plate forming a housing.

The housing of such sensors serves to accommodate various sensor components, in order to protect them against aggressive media. Where a sensor is used in a fuel tank, the housing must primarily be fuel-resistant and liquid-tight. A thin-walled metal cover is already used for this purpose, which in addition to the liquid-tight design of the housing at the same time affords adequate protection in that it is dimensionally stable under pressures in the order of 70 to 100 mbar occurring in the operation of the fuel tank. If the filling level sensor is already incorporated into a plastic preform used to form the subsequent fuel tank, rather than being fitted in the finished fuel tank, the filling level sensor may be exposed to substantially higher pressures in the order of 8 bar to 12 bar during the fuel tank manufacturing process. These high pressures result in deformations of the cover and the mounting plate, which in turn lead to fracture of the mounting plate, with the result that the tightness of the housing is no longer assured.

The object of the invention therefore is to create a filling level sensor, which in addition to resistance to ambient influences in its place of use is also resistant to pre-assembly under harsher ambient influences.

### BRIEF DESCRIPTION OF THE INVENTION

According to the invention this object is achieved in that the cover has at least one bead.

Arranging beads in the cover is an especially easy way of achieving a mechanical strengthening of the housing and therefore greater resistance of the cover to deformations, which in turn means that the mounting plate is more firmly supported, so that it is deformed to a lesser extent under greater pressures acting on the housing and is therefore not damaged, thereby maintaining the tightness of the housing. At the same time no additional material needs to be used in order to strengthen the housing. Since the strengthening relates solely to the cover, the remaining component parts of the filling level sensor can continue to be used without modification. Strengthening of the cover affords protection not only at high pressures, however, but also at very low pressures compared to normal pressure.

In addition to the subsequent formation of beads in the housing, these can also be produced in the same operation when manufacturing the housing. This development has the advantage that no additional machining stage is necessary. This is achieved by a correspondingly designed mold for the housing.

An especially high mechanical rigidity is achieved by providing all faces of the cover with beads. It has emerged, however, that it is sufficient just to strengthen individual areas of the cover. It is therefore not necessary to strengthen the entire housing, so that the cost of strengthening the housing is low.

Covers which have beads only on the upper side of the cover have proved to be particularly stable. Since the upper side of the cover is the largest face of the cover, arranging beads on this face in itself affords effective strengthening of the housing.

The number of beads on the upper side of the housing can be kept to a minimum if the beads are oriented parallel to the longest extent of the housing.

The housing of the filling level sensor does not take up any more overall space if the beads are arched in the direction of the interior of the housing. There is therefore no need for any adjustments to the mounting for the housing.

In a further advantageous development the beads are arranged between a side wall of the cover and the edge area. With this design the side wall area of the housing is strengthened, so that any flexure of the housing along the side walls is avoided. The number of beads to be provided depends on the loads occurring.

A reliable protection of the housing against exceptionally heavy loads is achieved by combining the arrangement of beads between the side walls and the edge area with the arrangement of beads in the upper side of the cover.

### BRIEF DESCRIPTION OF THE DRAWINGS

The invention will be explained in more detail with reference to two exemplary embodiments. In the drawings:

FIG. 1 shows an unstrengthened filling level sensor in a fuel tank,

FIG. 2 shows a perspective view of the housing of an inventive filling level sensor according to FIG. 1 and

FIG. 3 shows a second embodiment of the cover according to FIG. 2.

### DETAILED DESCRIPTION OF THE INVENTION

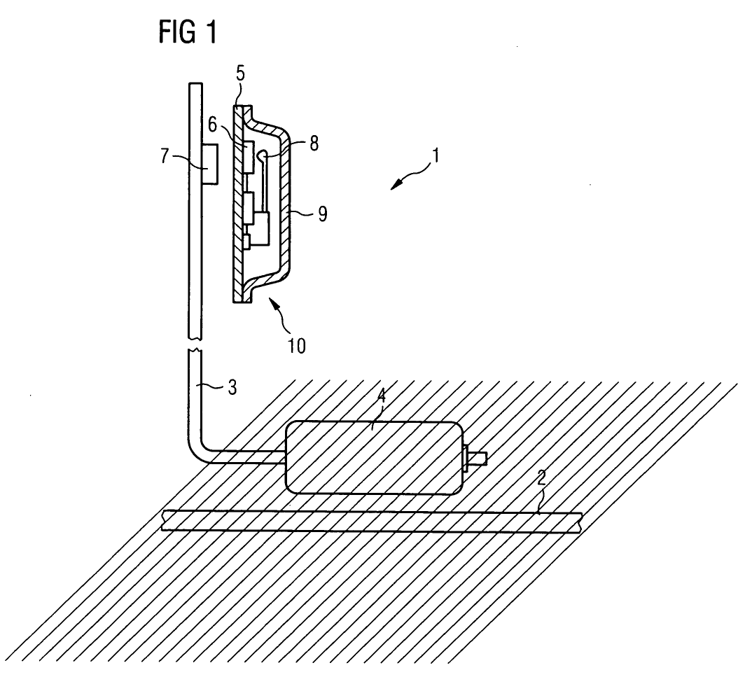

The filling level sensor I represented in FIG. 1 is arranged in a fuel tank 2. The filling level sensor 1 comprises a pivotally supported lever arm 3, at one end of which a float 4 is supported. The filling level sensor 1 furthermore has a ceramic mounting plate 5, on which an electrical resistance network 6 is applied. A contact structure 8, which can be deflected by the lever arm 3 by means of a magnet 7, generates an electrical filling level signal as a function of the lever arm position. The mounting plate 5 is connected to the cover 9, forming a housing 10 in such a way that the resistance network 6 and the contact structure 8 are sealed off from the surroundings.

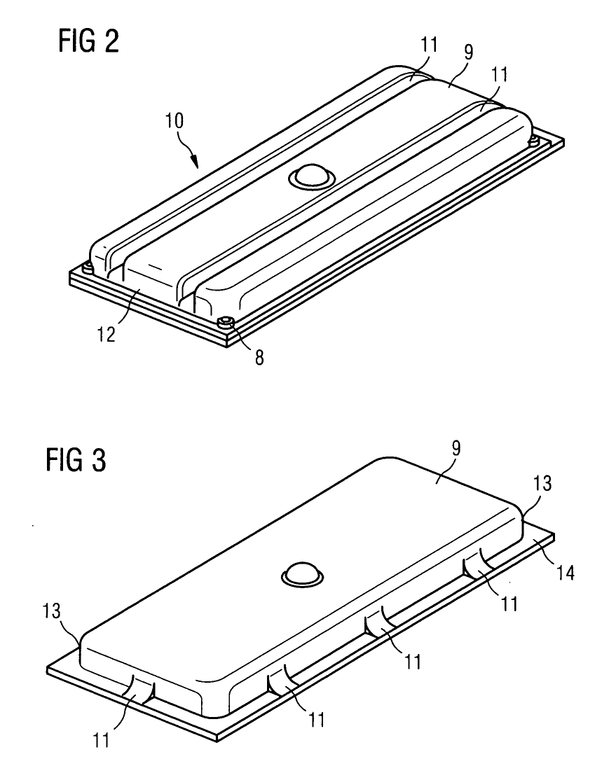

FIG. 2 shows the housing 10 of the filling level sensor comprising the cover 9 and the mounting plate 5. The cover 9 has two beads 11 for mechanical strengthening parallel to the greatest longitudinal extent of the housing 10. The beads 9 are arranged on the upper side of the cover 12. The beads 11 are at the same time arched in the direction of the interior of the housing, so that the cover 9 does not take up any more overall space than an unstrengthened cover. The cover 9 represented in FIG. 3 also has beads 11 for increasing the mechanical rigidity. The beads 11 are arranged between the side faces 13 and the edge 14 of the cover.

1. A filling level sensor for a fuel tank, comprising a ceramic mounting plate with a resistance network arranged thereon and a contact structure for the detection of an electrical filling level signal, and a cover connected to the mounting plate, the cover and the mounting plate forming a housing, characterized in that the cover (9) has at least one bead (11).

2. The filling level sensor as claimed in claim 1, characterized in that the beads (11) are arranged on the upper side of the cover (12).

3. The filling level sensor as claimed in claim 1 or 2, characterized in that the beads (11) are oriented parallel to the longest extent of the housing (10).

4. The filling level sensor as claimed in claim 1, characterized in that the beads (11) are arched in the direction of the interior of the housing.

5. The filling level sensor as claimed in claim 1, characterized in that the beads (11) are formed between a side wall (13) and the edge (14) of the cover (9).
